(19) United States
(12) Patent Application Publication
(10) Pub. No.: US 2011/0317213 A1
(43) Pub. Date: Dec. 29, 2011

(54) IMAGE PROCESSING APPARATUS AND IMAGE PROCESSING SYSTEM

(76) Inventor: Kentaro HIRAKI, Tokyo (JP)

(21) Appl. No.: 13/168,314

(22) Filed: Jun. 24, 2011

(30) Foreign Application Priority Data
Jun. 29, 2010 (JP) 2010-147772

(51) Int. Cl. G06F 3/12

(52) U.S. Cl. 358/1.15

(57) ABSTRACT

An image processing apparatus is to be connected to a receiving terminal, so that the image processing apparatus is capable of communicating with the receiving terminal. The image processing apparatus includes a reading generation unit for reading an original to generate image data; a display input unit for displaying an input screen of an identification mark of the receiving terminal so that a user inputs the identification mark; a transmission unit for transmitting the image data thus generated to the receiving terminal according to the identification mark thus input; and a control unit for controlling the reading generation unit to start reading the original and the display input unit to display the input screen.

### BACKGROUND OF THE INVENTION AND RELATED ART STATEMENT

The present invention relates to an image processing apparatus and an image processing system for performing a reading transmission process, in which an original is read to generate image data and the image data is transmitted. More specifically, the present invention relates to an image processing apparatus and an image processing system capable of reducing a period of time during which the image processing apparatus is occupied when the reading transmission process is performed.

In the conventional image processing system, a conventional image processing apparatus such as a copier is connected to a receiving terminal through a network such as Internet. When image data is transmitted to the receiving terminal, first, an original is placed on a reading unit of the conventional image processing apparatus. In the next step, an input instruction screen is displayed on the conventional image processing apparatus, so that a user can input an address of the receiving terminal (or a transmission destination) as an identification mark. After the user inputs the address, the conventional image processing apparatus starts reading the original to generate the image data, so that the image data thus generated is transmitted to the destination thus input.

Patent Reference has disclosed such a conventional image processing apparatus and such a conventional image processing system.
Patent Reference: Japanese Patent Publication No. 2008-236581

In the conventional image processing apparatus and the conventional image processing system, when the conventional image processing apparatus reads a plurality of originals in an original reading process, the conventional image processing apparatus may need to specify the destination of the image data thus read according to each of the originals thus read. Accordingly, it may be necessary to use an operational unit of the conventional image processing apparatus for a long period of time, thereby taking a long period of time to complete the original reading process.

In view of the problems described above, an object of the present invention is to provide an image processing apparatus capable of solving the problems of the conventional image processing apparatus and the conventional image processing system.

Further objects and advantages of the invention will be apparent from the following description of the invention.

### SUMMARY OF THE INVENTION

In order to attain the objects described above, according to an aspect of the present invention, an image processing apparatus is to be connected to a receiving terminal, so that the image processing apparatus is capable of communicating with the receiving terminal. The image processing apparatus includes a reading generation unit for reading an original to generate image data; a display input unit for displaying an input screen of an identification mark of the receiving terminal so that a user inputs the identification mark; a transmission unit for transmitting the image data thus generated to the receiving terminal according to the identification mark thus input; and a control unit for controlling the reading generation unit to start reading the original and the display input unit to display the input screen.

### BRIEF DESCRIPTION OF THE DRAWINGS

FIG. 1 is a block diagram showing a configuration of an image processing system according to a first embodiment of the present invention;

FIG. 2 is a flow chart showing an operation of the image processing system according to the first embodiment of the present invention;

FIG. 3 is a schematic view showing a reading prompt screen displayed on an image processing apparatus according to the first embodiment of the present invention;

FIG. 4 is a schematic view showing a transmission destination input screen displayed on the image processing apparatus according to the first embodiment of the present invention;

FIG. 5 is a block diagram showing a configuration of an image processing system according to a second embodiment of the present invention;

FIG. 6 is a block diagram showing a configuration of an image storage unit of an image processing apparatus according to the second embodiment of the present invention;

FIG. 7 is a flow chart showing an operation of the image processing system according to the second embodiment of the present invention;

FIG. 8 is a schematic view showing an input selection screen displayed on an image processing apparatus according to the second embodiment of the present invention;

FIG. 9 is a block diagram showing a configuration of an image processing system according to a third embodiment of the present invention;

FIG. 10 is a block diagram showing a configuration of an image storage unit of an image processing apparatus according to the third embodiment of the present invention;

FIG. 11 is a flow chart No. 1 showing an operation of the image processing system according to the third embodiment of the present invention;

FIG. 12 is a flow chart No. 2 showing the operation of the image processing system according to the third embodiment of the present invention;

FIG. 13 is a flow chart No. 3 showing the operation of the image processing system according to the third embodiment of the present invention;

FIG. 14 is a schematic view showing an catalog screen displayed on the information processing apparatus according to the third embodiment of the present invention;

FIG. 15 is a block diagram showing a configuration of an image processing system according to a fourth embodiment of the present invention;

FIG. 16 is a flow chart No. 1 showing an operation of the image processing system according to the fourth embodiment of the present invention; and

FIG. 17 is a flow chart No. 2 showing the operation of the image processing system according to the fourth embodiment of the present invention.

### DETAILED DESCRIPTION OF THE PREFERRED EMBODIMENTS

Hereunder, embodiments of the present invention will be explained with reference to the accompanying drawings.

### First Embodiment

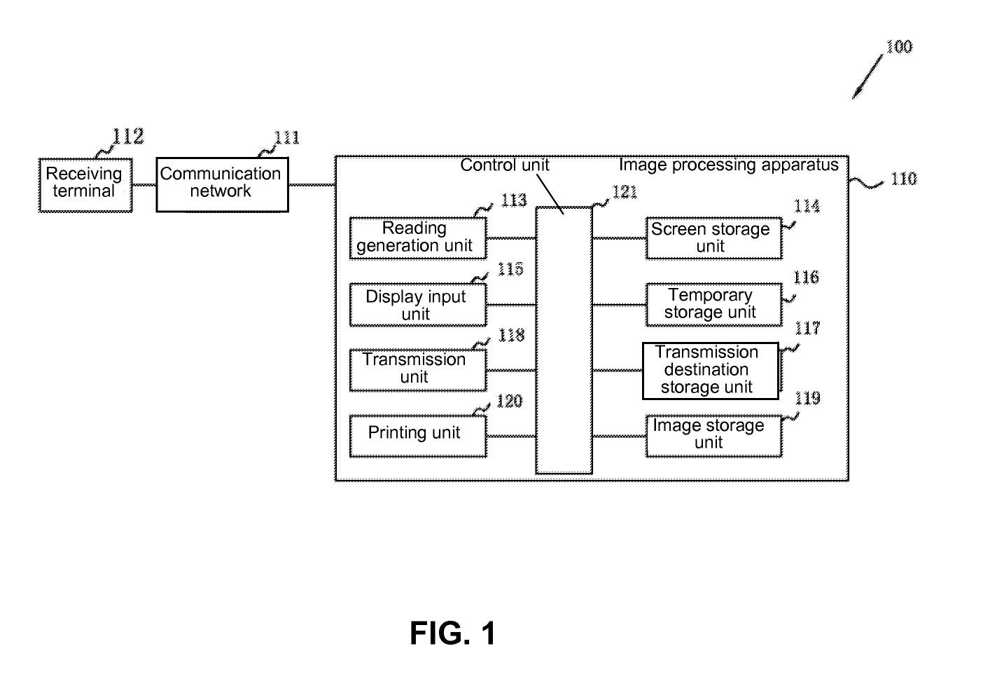

A first embodiment of the present invention will be explained. FIG. 1 is a block diagram showing a configuration of an image processing system 100 according to the first embodiment of the present invention.

As shown in FIG. 1, the image processing system 100 includes an image processing apparatus 110 and a receiving terminal 112 connected to the image processing apparatus 110 through a communication network 111, so that the receiving terminal 112 is capable of communicating with the image processing apparatus 110. The image processing apparatus 110 has a transmission function of transmitting image data of an original to the receiving terminal 112, and a copy function of copying the original.

In the embodiment, the image processing apparatus 110 includes a reading generation unit 113; a screen storage unit 114; a display input unit 115; a temporary storage unit 116; a transmission destination storage unit 117; a transmission unit 118; an image storage unit 119; a printing unit 120; and a control unit 121.

In the embodiment, the reading generation unit 113 has a function of reading the original placed on the image processing apparatus 110 and generating image data. The image storage unit 114 has a function of storing a transmission destination input screen for a user to input an address of the receiving terminal 112, that is, a transmission destination. Further, the screen storage unit 114 has a function of storing a function selection screen for the user to select the transmission function or the copy function of the image processing apparatus 110; a transmission method selection screen for the user to select a transmission method such as facsimile and an electric mail; and a reading prompt screen for the user to start a reading operation. The display input unit 115 has a display function of displaying the transmission destination input screen, the function selection screen, the transmission method selection screen, and the reading prompt screen. Further, the display input unit 115 has an input function of inputting data such as the transmission destination.

In the embodiment, the temporary storage unit 116 has a function of temporarily storing transmission destination data input by the user. Further, the temporary storage unit 116 has a function of temporarily storing transmission method data indicating a transmission method and specified by the user, and the image data generated with the reading generation unit 113. The transmission destination storage unit 117 has a function of storing the transmission destination data.

In the embodiment, the transmission unit 118 has a function of transmitting the image data to the receiving terminal 112 through the communication network 111 according to the transmission destination and the transmission method data. The image storage unit 119 has a function of storing the image data. The printing unit 120 has a function of printing the image data when the user selects the copy function. The control unit 121 has a function of controlling the reading generation unit 113, the screen storage unit 114, the display input unit 115, the temporary storage unit 116, the transmission destination storage unit 117, the transmission unit 118, the image storage unit 119, and the printing unit 120.

In the embodiment, the receiving terminal 112 of the image processing apparatus 110 may include a personal computer (PC) connected to the image processing apparatus 110 through the communication network 111 including a local area network (LAN). Further, the receiving terminal 112 may include a facsimile connected to the image processing apparatus 110 through the communication network 111 including a telephone network. When the receiving terminal 112 is the PC, an electrical mail address corresponds to the transmission destination. When the receiving terminal 112 is the facsimile, a facsimile number corresponds to the transmission destination.

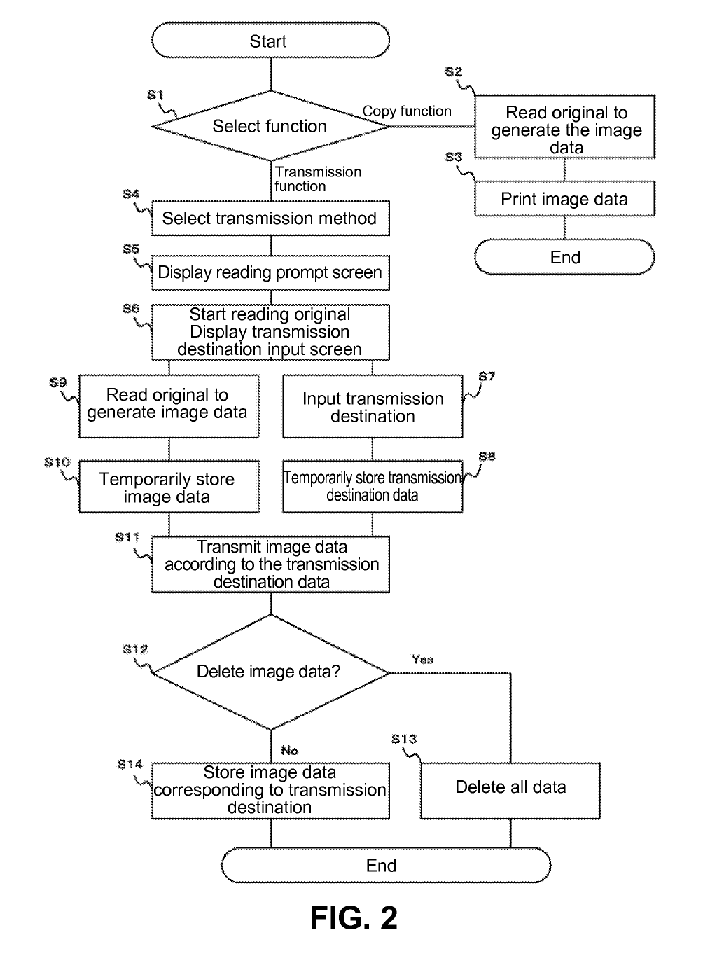

An operation of the image processing system 100 will be explained next with reference to a flow chart shown in FIG. 2. FIG. 2 is the flow chart showing the operation of the image processing system 100 according to the first embodiment of the present invention.

As shown in FIG. 2, in the image processing system 100, the control unit 121 starts the display input unit 115 first, so that the function selection screen is displayed on the display input unit 115. Accordingly, in step S1, it is possible for a user to select one of the copy function and the transmission function.

In step S2, when the user selects the copy function, the control unit 121 starts the reading generation unit 113, so that the reading generation unit 113 reads the original to generate the image data. Then, the control unit 121 controls the temporary storage unit 116 to temporarily store the image data thus generated. In step S3, the control unit 121 starts the printing unit 120, so that the printing unit 120 prints the image data temporarily stored in the temporary storage unit 116, thereby completing the process.

In step S4, when the user selects the transmission function, the control unit 121 displays the transmission method selection screen on the display input unit 115, so that the user can selects the transmission method. Then, the control unit 121 controls the temporary storage unit 116 to temporarily store the transmission method thus selected. In the embodiment, when the receiving terminal 112 is, for example, the PC, the user specifies an electric mail as the corresponding transmission method.

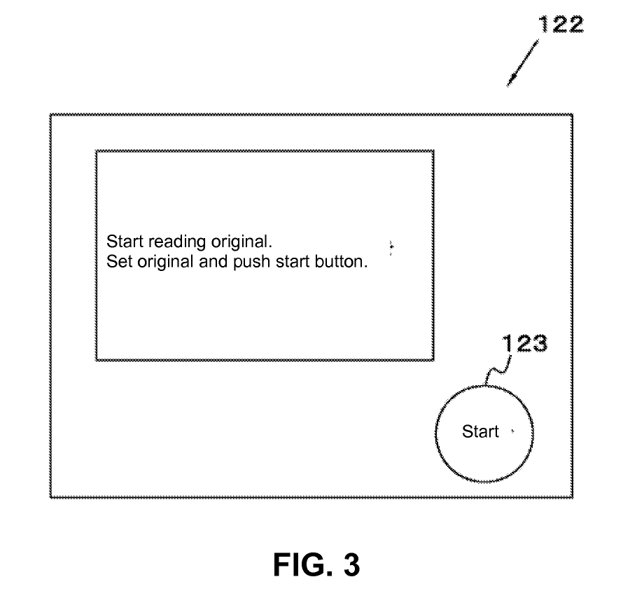

In step S5, the control unit 121 displays the reading prompt screen 122 on the display input unit 115. FIG. 3 is a schematic view showing the reading prompt screen 122 displayed on the display input unit 115 of the image processing apparatus 110 according to the first embodiment of the present invention.

As shown in FIG. 3, the reading prompt screen 122 includes a start button 123. In step S6, when the user pushes or touches the start button 123, the control unit 121 starts the reading generation unit 113, so that the reading generation unit 113 starts reading the original thus set. At the same time, the control unit 121 displays the transmission destination input screen 124 on the display input unit 115.

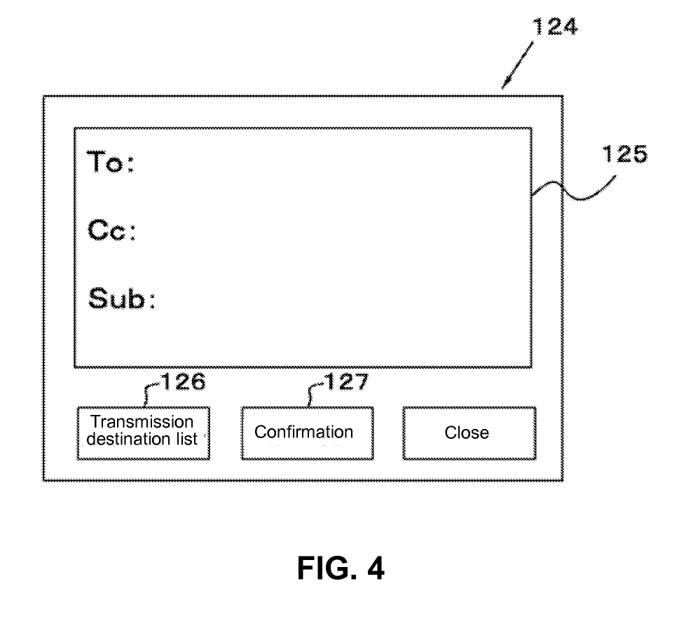

FIG. 4 is a schematic view showing the transmission destination input screen 124 displayed on the display input unit 115 of the image processing apparatus 110 according to the first embodiment of the present invention. As shown in FIG. 4, the transmission destination input screen 124 includes a transmission destination input area 125 for inputting a new transmission destination. Further, the transmission destination input screen 124 includes a transmission destination list 126 and a confirmation button 127.

In the embodiment, the user inputs a new transmission destination through the transmission destination input area 125 and pushes or touches the confirmation button 127, so that the user specifies the transmission destination. When the user pushes the transmission destination list 126 without inputting a new transmission destination, a list of transmission destinations stored in the transmission destination storage unit 117 in advance is displayed. Accordingly, the user can specifies one of the transmission destinations through the list.

In step S7, the user inputs the transmission destination, or specifies one of the transmission destinations through the list. In step S8, the control unit 121 controls the temporary storage unit 116 to temporarily store the transmission destination as transmission destination data. It is noted that when the user inputs a new transmission destination, the control unit 121 controls the transmission destination storage unit 117 to store the transmission destination thus input as well.

In step S9, the reading generation unit 113 reads the original to generate the image data. In step S10, the control unit 121 controls the temporary storage unit 116 to temporarily store the image data generated with the reading generation unit 113. In step S11, after the reading generation unit 113 reads the original and the transmission destination is input, the control unit 121 starts the transmission unit 118 to transmit the image data to the receiving terminal 112 according to the transmission destination data.

After the transmission unit 118 transmits the image data, the control unit 121 controls the display input unit 115 to display a notification indicating that the image data is transmitted. In step S12, the control unit 121 controls the display input unit 115 to display a deletion selection screen indicating whether the image data is to be deleted. It is noted that the deletion selection screen is provided for prompting the user to select whether the image data is to be deleted.

In step S13, when the user selects that the image data is to be deleted, the control unit 121 deletes all data including the image data stored in the temporary storage unit 116, thereby completing the process. In step S14, when the user selects that the image data is not to be deleted, the control unit 121 controls the image storage unit 119 to store the image data stored in the temporary storage unit 116 corresponding to the transmission destination, and deletes the image data stored in the temporary storage unit 116, thereby completing the process.

In the first embodiment, immediately after the original is placed, the reading generation unit 113 starts reading the original and the transmission destination is input. Accordingly, it is not necessary to occupy the image processing apparatus 110 for inputting the transmission destination, thereby reducing a period of time to occupy the image processing apparatus 110 in the original reading transmission process. Accordingly, when the image processing apparatus 110 reads a plurality of originals in the original reading transmission process, it is possible to continuously perform the original reading transmission process, thereby making it possible to reduce a waiting time of the user. As a result, it is possible to continuously perform the original reading transmission process for a large number of originals in a short period of time.

### Second Embodiment

A second embodiment of the present invention will be explained. In the second embodiment, components similar to those in the first embodiment are designated with the same reference numerals, and explanations thereof are omitted.

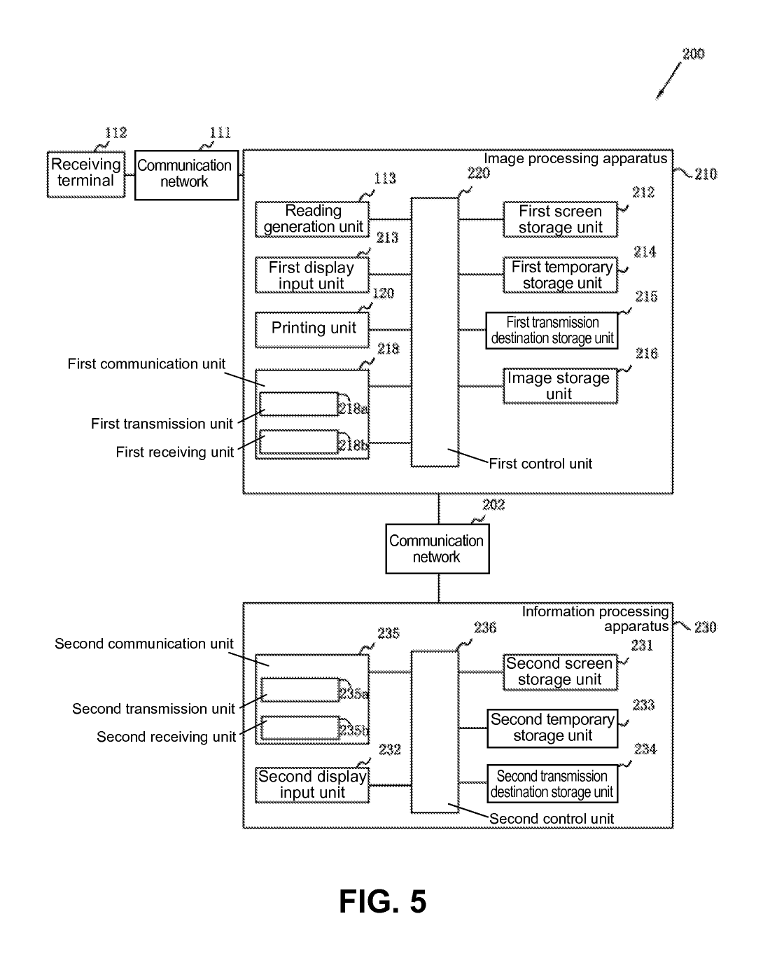

FIG. 5 is a block diagram showing a configuration of an image processing system 200 according to the second embodiment of the present invention.

As shown in FIG. 5, the image processing system 200 includes the receiving terminal 112, an image processing apparatus 210 connected to the receiving terminal 112 through the communication network 111, and an information processing apparatus 230 connected to the image processing apparatus 210 through a communication network 202, so that the information processing apparatus 230 is capable of communicating with the image processing apparatus 210.

In the embodiment, the image processing apparatus 210 has a transmission function of transmitting image data of an original to the receiving terminal 112, and a copy function of copying the original. The image processing apparatus 210 includes the reading generation unit 113; a first screen storage unit 212; a first display input unit 213; a first temporary storage unit 214; a first transmission destination storage unit 215; an image storage unit 216; a first communication unit 218; the printing unit 120; and a first control unit 220.

In the embodiment, the first screen storage unit 212 has a function of storing an input selection screen for a user to select whether a transmission destination is input through the image processing apparatus 210, and a transmission destination input screen for the user to input the transmission destination. Further, the first screen storage unit 212 has a function of storing a function selection screen for the user to select the transmission function or the copy function of the image processing apparatus 210; a transmission method selection screen for the user to select a transmission method such as facsimile and an electric mail; and the reading prompt screen 122 for the user to start a reading operation.

In the embodiment, the first display input unit 213 has a display function of displaying the input selection screen, the transmission destination input screen, the function selection screen, the transmission method selection screen, and the reading prompt screen. Further, the first display input unit 213 has an input function of inputting data such as the transmission destination.

In the embodiment, the first temporary storage unit 214 has a function of temporarily storing transmission destination data input by the user. Further, the first temporary storage unit 214 has a function of temporarily storing the image data generated with the reading generation unit 113. The first transmission destination storage unit 215 has a function of storing the transmission destination.

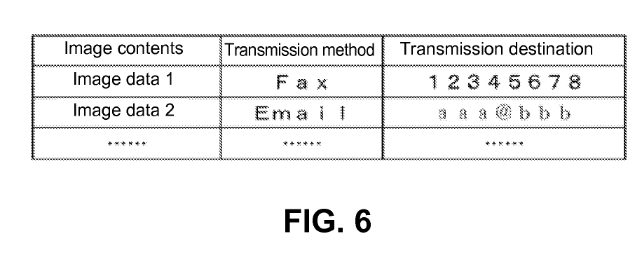

FIG. 6 is a block diagram showing a configuration of the image storage unit 216 of the image processing apparatus 210 according to the second embodiment of the present invention.

As shown in FIG. 6, the image storage unit 216 includes items such as image contents, a transmission method, and a transmission destination. According to the items, the image storage unit 216 is provided for storing the image data such as image data 1 and image data 2, the transmission method data such as a facsimile (FAX) and an electric mail (Email), and the transmission destination such as “12345678” and “aaa@bbb”.

In the embodiment, the first communication unit 218 includes a first transmission unit 218a and a first receiving unit 218b. The first transmission unit 218a has a function of transmitting various data and a control signal to the receiving terminal 112 and the information processing apparatus 230. The first receiving unit 218b has a function of receiving data and the control signal from the information processing apparatus 230.

In the embodiment, the information processing apparatus 230 includes a second screen storage unit 231; a second display input unit 232; a second temporary storage unit 233; a second transmission destination storage unit 234; a second communication unit 235; and a second control unit 236.

In the embodiment, the second screen storage unit 231 has a function of storing a transmission destination input screen for the user to input the transmission destination. The second display input unit 232 has a display function of displaying the transmission destination input screen, and an input function of inputting data such as the transmission destination. The second temporary storage unit 233 has a function of temporarily storing data input through the second display input unit 232 and data received from the image processing apparatus 210.

In the embodiment, the second transmission destination storage unit 234 has a function of storing the transmission destination. The second communication unit 235 includes a second transmission unit 235a and a second receiving unit 235b, and has a function of communicating with the image processing apparatus 210. The first receiving unit 218b has a function of receiving data and the control signal from the information processing apparatus 230. The second control unit 236 has a function of controlling the second screen storage unit 231, the second display input unit 232, the second temporary storage unit 233, the second transmission destination storage unit 234, and the second communication unit 235 of the information processing apparatus 230.

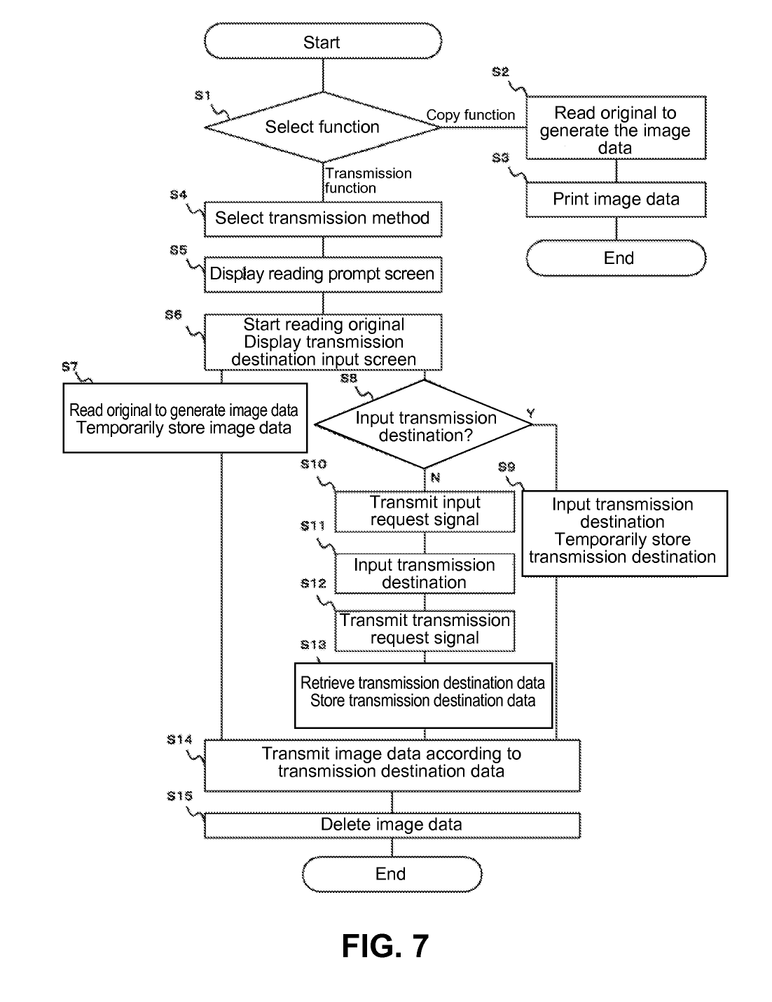

An operation of the image processing system 200 will be explained next with reference to a flow chart shown in FIG. 7. FIG. 7 is the flow chart showing the operation of the image processing system 200 according to the second embodiment of the present invention.

As shown in FIG. 7, in the image processing system 200, the first control unit 220 starts the first display input unit 213 first, so that the function selection screen is displayed on the first display input unit 213. Accordingly, in step S1, it is possible for the user to select one of the copy function and the transmission function.

In step S2, when the user selects the copy function, the first control unit 220 starts the reading generation unit 113, so that the reading generation unit 113 reads the original to generate the image data. Then, the first control unit 220 controls the first temporary storage unit 214 to temporarily store the image data thus generated. In step S3, the first control unit 220 starts the printing unit 120, so that the printing unit 120 prints the image data temporarily stored in the first temporary storage unit 214, thereby completing the process.

In step S4, when the user selects the transmission function, the first control unit 220 displays the transmission method selection screen on the first display input unit 213, so that the user can selects the transmission method. Then, the first control unit 220 controls the image storage unit 216 to store the transmission method thus selected. In the embodiment, when the receiving terminal 112 is, for example, the PC, the user specifies an electric mail as the corresponding transmission method.

In step S5, the first control unit 220 displays the reading prompt screen 122 on the first display input unit 213. In step S6, when the user pushes or touches the start button 123 of the reading prompt screen 122, the first control unit 220 starts the reading generation unit 113, so that the reading generation unit 113 starts reading the original thus set. At the same time, the first control unit 220 displays the transmission destination input screen on the first display input unit 213. In step S7, the reading generation unit 113 reads the original to generate the image data, and the first control unit 220 controls the image storage unit 216 to temporarily store the image data generated with the reading generation unit 113.

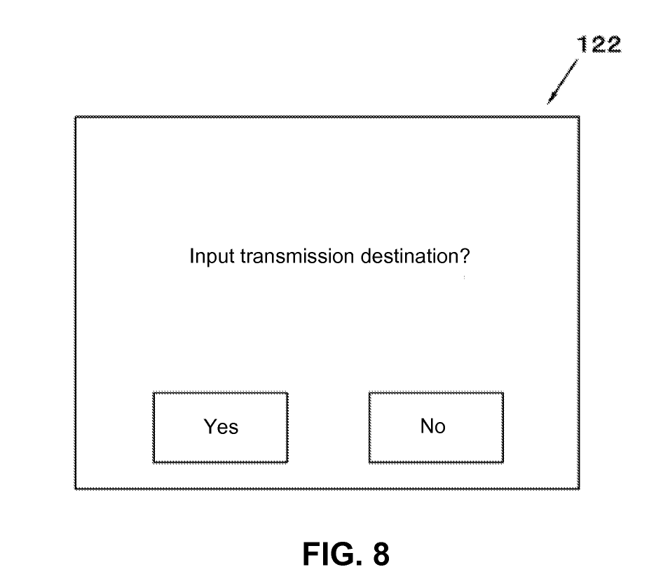

In step S8, the first control unit 220 prompts the user to select whether the user inputs the transmission destination on the image processing apparatus 210 through the input selection screen. FIG. 8 is a schematic view showing the input selection screen 217 displayed on the image processing apparatus 210 according to the second embodiment of the present invention.

As shown in FIG. 8, the input selection screen 217 includes a “Yes” button indicating that the user wants to input the transmission destination and a “No” button indicating that the user does not want to input the transmission destination. When the user pushes or touches the “Yes” button, the first control unit 220 displays the transmission destination input screen 124 on the first display input unit 213 corresponding to the transmission method stored in the image storage unit 216. Accordingly, in step S9, the user inputs the transmission destination, and the first control unit 220 controls the image storage unit 216 to temporarily store the transmission destination thus input as the transmission destination data.

In step S10, when the user pushes or touches the “No” button, the first control unit 220 controls the first transmission unit 218a of the first communication unit 218 to transmit an input request signal of the transmission destination to the information processing apparatus 230. The input request signal includes the transmission method data stored in the image storage unit 216.

In the information processing apparatus 230, the second control unit 236 receives the input request signal through the second receiving unit 235b of the second communication unit 235. In step S11, the second control unit 236 displays the transmission destination input screen 124 on the second display input unit 232, so that the user inputs the transmission destination. Afterward, the second control unit 236 controls the second temporary storage unit 233 to store the transmission destination thus input as the transmission destination data.

In step S12, the second control unit 236 generates a transmission request signal including the transmission destination thus input, and controls the second transmission unit 235a of the second communication unit 235 to transmit the transmission request signal to the image processing apparatus 210. In the image processing apparatus 210, the first control unit 220 receives the transmission request signal from the information processing apparatus 230. In step S13, the first control unit 220 retrieves the transmission destination data from the transmission request signal, and controls the image storage unit 216 to store the transmission destination data.

In step S14, after the image data is generated and stored in step S7, or the transmission destination is input and stored in step S9 or step S13, the first control unit 220 controls the first transmission unit 218a to transmit the image data to the receiving terminal 112 according to the transmission destination data. In step S15, after the first transmission unit 218a transmits the image data, the first control unit 220 deletes the image data stored in the image storage unit 216, thereby completing the process.

As described above, in the second embodiment, immediately after the original set, the reading of the original starts regardless whether the transmission destination is input. Then, the user can select whether the transmission destination is input on the image processing apparatus 210 while reading the original or on the information processing apparatus 230 connected to the image processing apparatus 210. Accordingly, the transmission destination is input without occupying only the image processing apparatus 210, thereby reducing downtime of the image processing apparatus 210 in the original reading transmission process.

Accordingly, when the image processing apparatus 210 reads a plurality of originals in the original reading transmission process, it is possible to continuously perform the original reading transmission process, thereby making it possible to reduce a waiting time of the user. As a result, it is possible to continuously perform the original reading transmission process for a large number of originals in a short period of time.

### Third Embodiment

A third embodiment of the present invention will be explained. In the third embodiment, components similar to those in the second embodiment are designated with the same reference numerals, and explanations thereof are omitted.

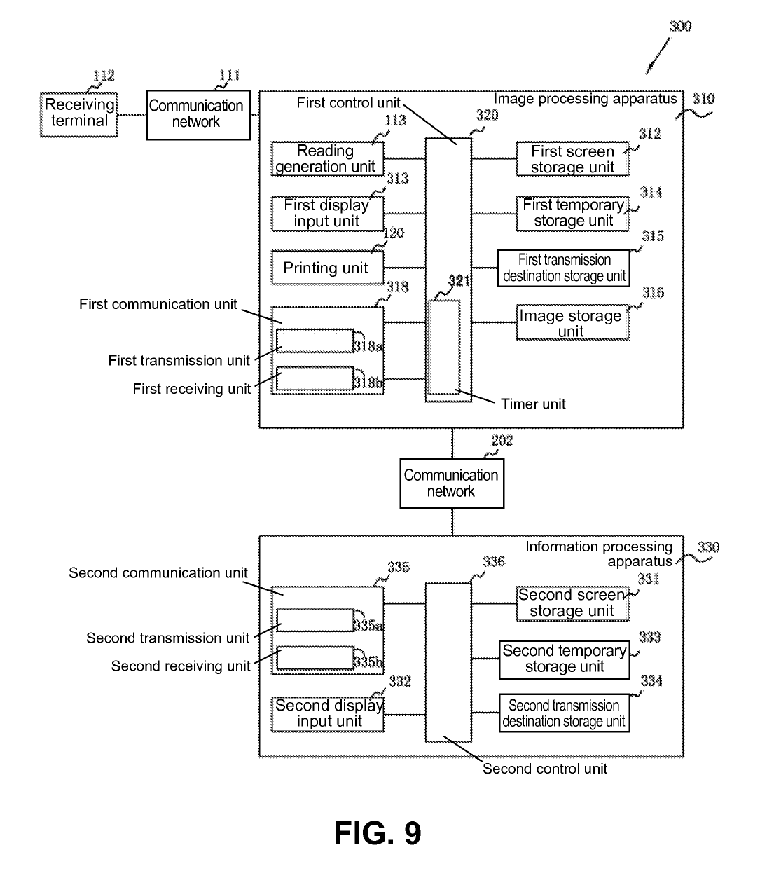

FIG. 9 is a block diagram showing a configuration of an image processing system 300 according to the third embodiment of the present invention.

As shown in FIG. 9, the image processing system 300 includes the receiving terminal 112, an image processing apparatus 310 connected to the receiving terminal 112 through the communication network 111, and an information processing apparatus 330 connected to the image processing apparatus 310 through the communication network 202, so that the information processing apparatus 330 is capable of communicating with the image processing apparatus 310.

In the embodiment, the image processing apparatus 310 has a transmission function of transmitting image data of an original to the receiving terminal 112, and a copy function of copying the original. The image processing apparatus 310 includes the reading generation unit 113; a first screen storage unit 312; a first display input unit 313; a first temporary storage unit 314; a first transmission destination storage unit 315; an image storage unit 316; a first communication unit 318; the printing unit 120; and a first control unit 320.

In the embodiment, the first screen storage unit 312 has a function of storing the input selection screen 217 for a user to select whether a transmission destination is input through the image processing apparatus 310, and a transmission destination input screen for the user to input the transmission destination. Further, the first screen storage unit 312 has a function of storing a function selection screen for the user to select the transmission function or the copy function of the image processing apparatus 310; a transmission method selection screen for the user to select a transmission method such as facsimile and an electric mail; and the reading prompt screen 122 for the user to start a reading operation.

In the embodiment, the first display input unit 313 has a display function of displaying the input selection screen 217, the transmission destination input screen 124, the function selection screen, the transmission method selection screen, and the reading prompt screen 122. Further, the first display input unit 313 has an input function of inputting data such as the transmission destination.

In the embodiment, the first temporary storage unit 314 has a function of temporarily storing transmission destination data input by the user. Further, the first temporary storage unit 314 has a function of temporarily storing the image data generated with the reading generation unit 113. The first transmission destination storage unit 315 has a function of storing the transmission destination.

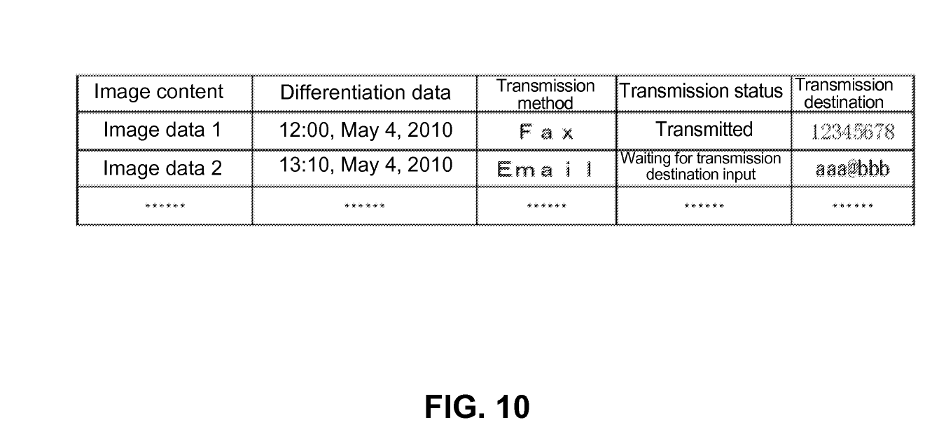

FIG. 10 is a block diagram showing a configuration of the image storage unit 316 of the image processing apparatus 310 according to the third embodiment of the present invention.

As shown in FIG. 10, the image storage unit 316 includes items such as image contents, differentiation data, a transmission method, a transmission status, and a transmission destination. According to the items, the image storage unit 316 is provided for storing the image data such as image data 1 and image data 2, the differentiation data such as “12:00, May 4, 2010” and “13:10, May 4, 2010”, the transmission method data such as a facsimile (FAX) and an electric mail (Email), the transmission status such as “waiting for transmission destination input” and “transmitted”, and the transmission destination such as “12345678” and “aaa@bbb” corresponding to the transmission status of “transmitted”.

In the embodiment, the image data represents contents of the original, and the transmission destination data represents the transmission destination input by the user. Further, the transmission method data represents the transmission method of the image data, and the transmission status data represents the transmission status of the image data. Further, the differentiation data has a function of differentiating the image data from other image data.

In the embodiment, the differentiation data represents date and time when the image data is generated for differentiating the image data. The differentiation data may represent other items such as a title of the original for differentiating the image data.

In the embodiment, the first communication unit 318 includes a first transmission unit 318a and a first receiving unit 318b. The first transmission unit 318a has a function of transmitting various data and a control signal to the receiving terminal 112 and the information processing apparatus 330. The first receiving unit 318b has a function of receiving data and the control signal from the information processing apparatus 330.

In the embodiment, the first control unit 320 has a function of controlling the reading generation unit 113, the first screen storage unit 312, the first display input unit 313, the first temporary storage unit 314, the first transmission destination storage unit 315, the image storage unit 316, the first communication unit 318, and the printing unit 120 of the information processing apparatus 330. Further, the first control unit 320 includes a timer unit 321.

In the embodiment, the information processing apparatus 330 includes a second screen storage unit 331; a second display input unit 332; a second temporary storage unit 333; a second transmission destination storage unit 334; a second communication unit 335; and a second control unit 336.

In the embodiment, the second screen storage unit 331 has a function of storing the transmission destination input screen 124 for the user to input the transmission destination, and a catalog screen for displaying a catalog of the image data. The second display input unit 332 has a display function of displaying the transmission destination input screen 124, and an input function of inputting data such as the transmission destination. The second temporary storage unit 333 has a function of temporarily storing data input through the second display input unit 332 and data received from the image processing apparatus 310.

In the embodiment, the second transmission destination storage unit 334 has a function of storing the transmission destination. The second communication unit 335 includes a second transmission unit 335a and a second receiving unit 335b, and has a function of communicating with the image processing apparatus 310. The second control unit 336 has a function of controlling the second screen storage unit 331, the second display input unit 332, the second temporary storage unit 333, the second transmission destination storage unit 334, and the second communication unit 335 of the information processing apparatus 330.

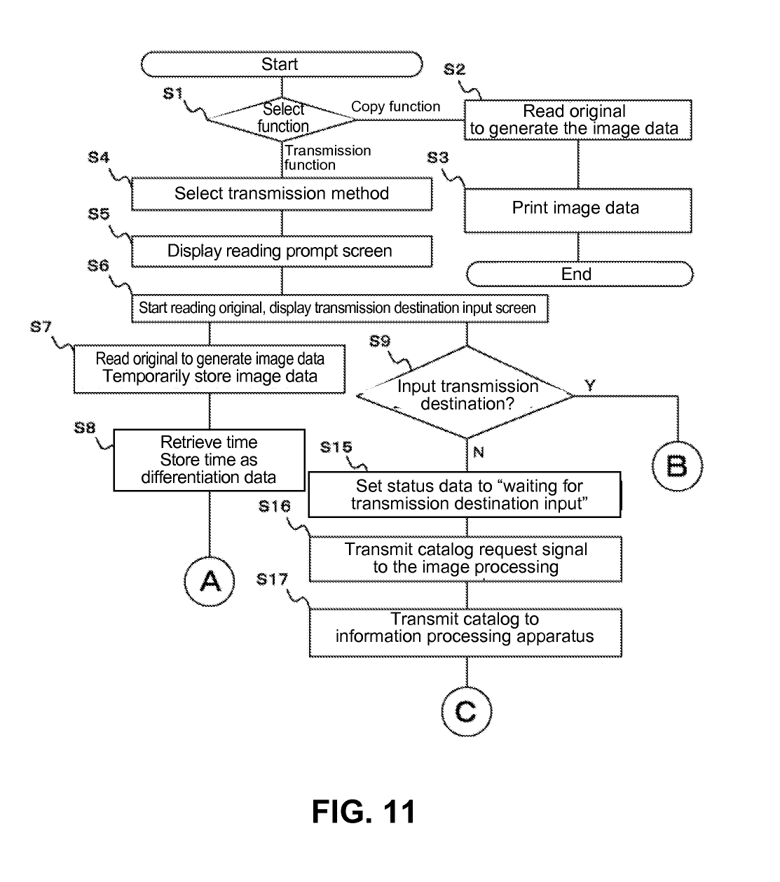

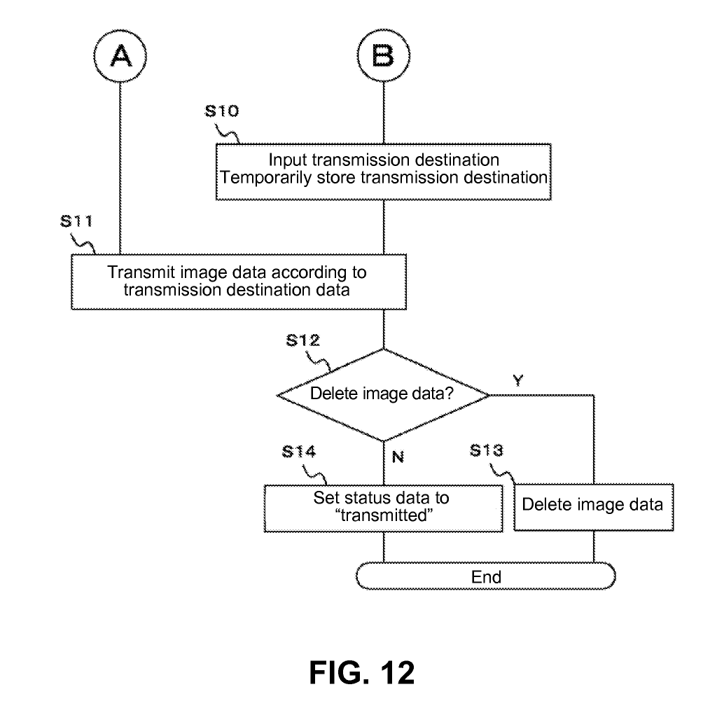

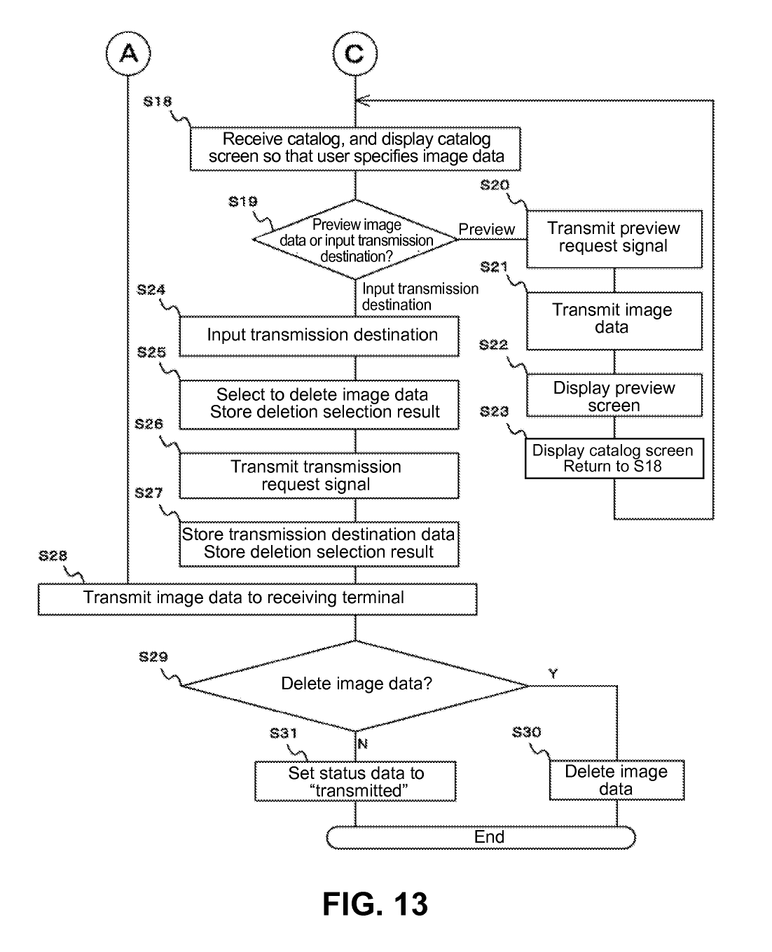

An operation of the image processing system 300 will be explained next with reference to flow charts No. 1 to No. 3 shown in FIGS. 11, 12 and 13. FIG. 11 is the flow chart No. 1 showing the operation of the image processing system 300 according to the third embodiment of the present invention. FIG. 12 is the flow chart No. 2 showing the operation of the image processing system 300 according to the third embodiment of the present invention. FIG. 13 is the flow chart No. 3 showing the operation of the image processing system 300 according to the third embodiment of the present invention.

As shown in FIG. 11, in the image processing apparatus 310, the first control unit 320 starts the first display input unit 313 first, so that the function selection screen is displayed on the first display input unit 313. Accordingly, in step S1, it is possible for the user to select one of the copy function and the transmission function.

In step S2, when the user selects the copy function, the first control unit 320 starts the reading generation unit 113, so that the reading generation unit 113 reads the original to generate the image data. Then, the first control unit 320 controls the first temporary storage unit 314 to temporarily store the image data thus generated. In step S3, the first control unit 320 starts the printing unit 120, so that the printing unit 120 prints the image data temporarily stored in the first temporary storage unit 314, thereby completing the process.

In step S4, when the user selects the transmission function, the first control unit 320 displays the transmission method selection screen on the first display input unit 313, so that the user can selects the transmission method. Then, the first control unit 320 controls the image storage unit 316 to store the transmission method thus selected. In the embodiment, when the receiving terminal 112 is, for example, the PC, the user specifies an electric mail as the corresponding transmission method.

In step S5, the first control unit 320 displays the reading prompt screen 122 on the first display input unit 313. In step S6, when the user pushes or touches the start button 123 of the reading prompt screen 122, the first control unit 320 starts the reading generation unit 113, so that the reading generation unit 113 starts reading the original thus set. At the same time, the first control unit 320 displays the transmission destination input screen on the first display input unit 313. In step S7, the reading generation unit 113 reads the original to generate the image data, and the first control unit 320 controls the image storage unit 316 to temporarily store the image data generated with the reading generation unit 113.

In step S8, the first control unit 320 retrieves a time when the image data is generated from the timer unit 321, and controls the image storage unit 316 to store the time as the differentiation data. In step S9, the first control unit 320 prompts the user to select whether the user inputs the transmission destination on the image processing apparatus 310 through the input selection screen.

When the user selects to input the transmission destination, as shown in FIG. 12, the first control unit 320 displays the transmission destination input screen 124 on the first display input unit 313 corresponding to the transmission method stored in the image storage unit 316. Accordingly, in step S10, the user inputs the transmission destination, and the first control unit 320 controls the image storage unit 316 to store the transmission destination thus input as the transmission destination data.

In step S11, after the image data is generated and stored in step S7, and the transmission destination is input and stored in step S10, the first control unit 320 controls the first transmission unit 318a to transmit the image data to the receiving terminal 112 according to the transmission destination data. In step S12, after the first transmission unit 318a transmits the image data, the first control unit 320 controls the first display input unit 313 to display the deletion selection screen whether the user selects to delete the image data thus transmitted.

In step S13, when the user selects to delete the image data, the first control unit 320 deletes the image data stored in the image storage unit 316, thereby completing the process. In step S14, when the user does not select to delete the image data, the first control unit 320 sets the status data of the image data thus transmitted to “transmitted”, thereby completing the process.

In step S15, when the user does not select to input the transmission destination in step S9, the first control unit 320 sets the status data corresponding to the image data to “waiting for transmission destination input”, and controls the image storage unit 316 to store the status data.

In step S16, in the information processing apparatus 330, the second control unit 336 controls the second transmission unit 335a of the second communication unit 335 to transmit a catalog request signal to the image processing apparatus 310. In the image processing apparatus 310, when the first control unit 320 receives the catalog request signal through the first receiving unit 318a of the first communication unit 318, the first control unit 320 retrieves the differentiation data, the transmission method data, and the status data of the image data from the image storage unit 316. In step S17, the first control unit 320 generates the catalog of the image data, and controls the first transmission unit 318a to transmit the catalog to the information processing apparatus 330.

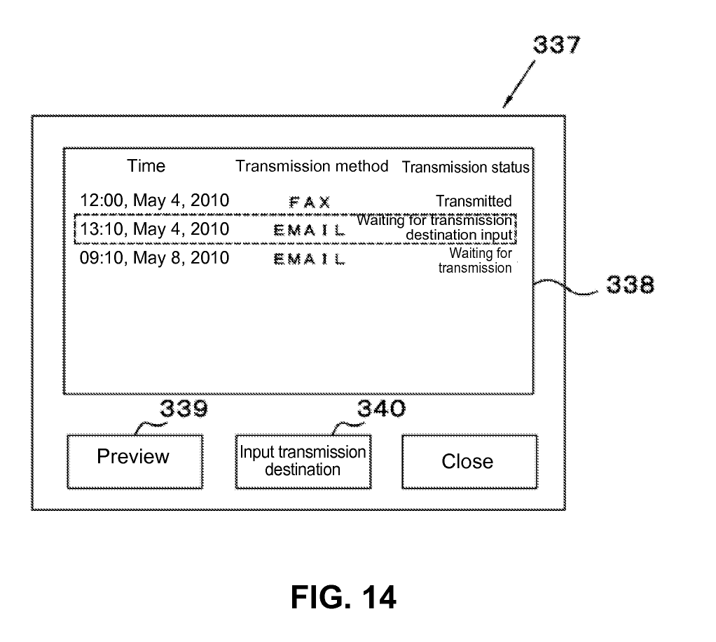

In step S18, in the information processing apparatus 330, the second control unit 336 controls the second temporary storage unit 333 to store the catalog received from the image processing apparatus 310 as shown in FIG. 13. Further, the second control unit 336 controls the second display input unit 332 to display a catalog screen 337 so that the user specifies the image data. FIG. 14 is a schematic view showing the catalog screen 337 displayed on the information processing apparatus 330 according to the third embodiment of the present invention.

As shown in FIG. 14, the catalog screen 337 includes an image specifying region 338 for the user to specify the image data through the catalog of the image data, a preview button 339, and a transmission destination input button 340. The user specifies the image data in the image specifying region 338 in step S18.

In step S19, the user pushes or touches the preview button 339 or the transmission destination input button 340 so that the user selects whether the user wants to preview the image data or input the transmission destination.

In step S20, when the user pushes or touches the preview button 339, the second control unit 336 controls the second transmission unit 335a to transmit a preview request signal with the differentiation data of the image data thus specified to the image processing apparatus 310.

In the image processing apparatus 310, when the first control unit 320 receives the preview request signal through the first receiving unit 318b, the first control unit 320 retrieves the image data thus specified from the image storage unit 316 according to the differentiation data contained in the preview request signal. In step S21, the first control unit 320 controls the first transmission unit 318a to transmit the image data thus specified to the information processing apparatus 330.

In step S22, in the information processing apparatus 330, the second control unit 336 controls the second display input unit 332 to display a preview screen according to the image data received from the image processing apparatus 310. It is noted that the preview screen includes a return button representing “return to the catalog screen”. In step S23, when the user pushes or touches the return button, the second control unit 336 controls the second display input unit 332 to display the catalog screen 337, thereby returning the process to step S18.

When the user pushes or touches the transmission destination input button 340 and selects to input the transmission destination in step S19, the second control unit 336 displays the transmission destination input screen 124 on the second display input unit 332. Accordingly, in step S24, the user inputs the transmission destination, and the second control unit 336 controls the second temporary storage unit 333 to store the transmission destination thus input as the transmission destination data.

In step S25, after the user inputs the transmission destination, the second control unit 336 controls the second display input unit 332 to display the deletion selection screen so that the user selects to delete the image data thus transmitted. Then, the second control unit 336 controls the second temporary storage unit 333 to store a deletion selection result.

In step S26, the second control unit 336 generates the transmission request signal including the differentiation data of the image data thus specified, the transmission destination thus input, and the deletion selection result. Then, the second control unit 336 controls the second communication unit 335 to transmit the transmission request signal to the image processing apparatus 310.

In step S27, in the image processing apparatus 310, when the first control unit 320 receives the transmission request signal from the information processing apparatus 330, the first control unit 320 retrieves the transmission destination data contained in the transmission request signal, and controls the image storage unit 316 to store the transmission destination data according to the differentiation data contained in the transmission request signal. Further, the first control unit 320 controls the first temporary storage unit 314 to store the deletion selection result contained in the transmission request signal.

In step S28, after the transmission destination is receives and stored, the first control unit 320 controls the first transmission unit 318a to transmit the image data to the receiving terminal 112 according to the transmission destination data. In step S29, after the first transmission unit 318a transmits the image data, the first control unit 320 determines whether the image data thus transmitted is deleted according to the deletion selection result stored in the first temporary storage unit 314.

In step S30, when the first control unit 320 determines that the image data is deleted, the first control unit 320 deletes the image data stored in the image storage unit 316, thereby completing the process. In step S31, when the first control unit 320 determines that the image data is not deleted, the first control unit 320 updates the status data corresponding to the image data to “transmitted”, thereby completing the process.

As described above, in the third embodiment, it is possible for the user to interrupt the operation for a while after the image processing apparatus 310 reads the original and generates the image data, and to resume the operation of inputting the transmission destination on the information processing apparatus 330 at a convenient time according to own schedule. Further, when the transmission destination is input on the information processing apparatus 330, it is possible to specify from the catalog only the image data necessary for the user according to the differentiation data. Further, it is possible to preview the image data thus specified. Accordingly, it is possible to perform the accurate transmission operation.

### Fourth Embodiment

A fourth embodiment of the present invention will be explained. In the fourth embodiment, components similar to those in the third embodiment are designated with the same reference numerals, and explanations thereof are omitted.

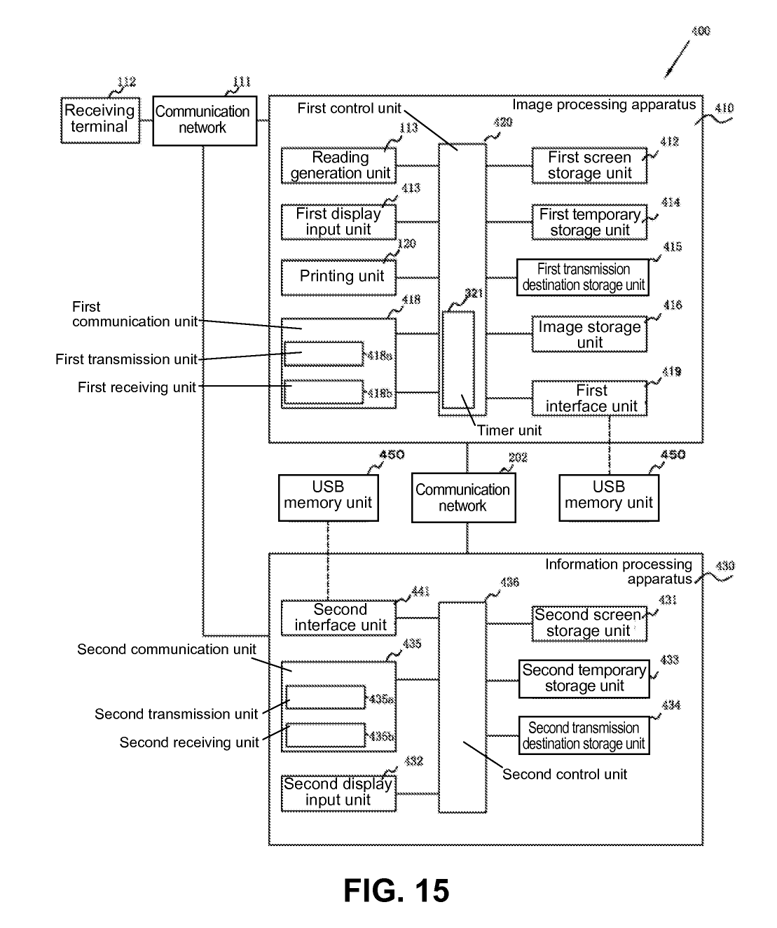

FIG. 15 is a block diagram showing a configuration of an image processing system 400 according to the third embodiment of the present invention.

As shown in FIG. 15, the image processing system 400 includes the receiving terminal 112, an image processing apparatus 410 connected to the receiving terminal 112 through the communication network 111, and an information processing apparatus 430 connected to the image processing apparatus 410 through the communication network 202, so that the information processing apparatus 430 is capable of communicating with the image processing apparatus 410. The image processing system 400 further includes USB memory units 450 compatible with both the image processing apparatus 410 and the information processing apparatus 430.

In the embodiment, the image processing apparatus 410 has a transmission function of transmitting image data of an original to the receiving terminal 112, and a copy function of copying the original. The image processing apparatus 410 includes the reading generation unit 113; a first screen storage unit 412; a first display input unit 413; a first temporary storage unit 414; a first transmission destination storage unit 415; an image storage unit 416; a first communication unit 418; a first interface unit 419; the printing unit 120; and a first control unit 420.

In the embodiment, the first screen storage unit 412 has a function of storing the input selection screen 217 for a user to select whether a transmission destination is input through the image processing apparatus 410, and a transmission destination input screen for the user to input the transmission destination. Further, the first screen storage unit 412 has a function of storing a function selection screen for the user to select the transmission function or the copy function of the image processing apparatus 410; a transmission method selection screen for the user to select a transmission method such as facsimile and an electric mail; and the reading prompt screen 122 for the user to start a reading operation.

In the embodiment, the first display input unit 413 has a display function of displaying the input selection screen 217, the transmission destination input screen 124, the function selection screen, the transmission method selection screen, and the reading prompt screen 122. Further, the first display input unit 413 has an input function of inputting data such as the transmission destination.

In the embodiment, the first temporary storage unit 414 has a function of temporarily storing transmission destination data input by the user. Further, the first temporary storage unit 414 has a function of temporarily storing the image data generated with the reading generation unit 113. The first transmission destination storage unit 415 has a function of storing the transmission destination.

In the embodiment, the image storage unit 416 includes items such as image contents, differentiation data, a transmission method, a transmission status, and a transmission destination. According to the items, the image storage unit 416 is provided for storing the image data such as image data 1 and image data 2, the differentiation data such as “12:00, May 4, 2010” and “13:10, May 4, 2010”, the transmission method data such as a facsimile (FAX) and an electric mail (Email), the transmission status such as “waiting for transmission destination input” and “transmitted”, and the transmission destination such as “12345678” and “aaa@bbb” corresponding to the transmission status of “transmitted”.

In the embodiment, the image data represents contents of the original, and the transmission destination data represents the transmission destination input by the user. Further, the transmission method data represents the transmission method of the image data, and the transmission status data represents the transmission status of the image data. Further, the differentiation data has a function of differentiating the image data from other image data.

In the embodiment, the first communication unit 418 includes a first transmission unit 418a and a first receiving unit 418b. The first transmission unit 418a has a function of transmitting various data and a control signal to the receiving terminal 112 and the information processing apparatus 430. The first receiving unit 418b has a function of receiving data and the control signal from the information processing apparatus 430. The first interface unit 419 has a function of connecting and communicating with the USB memory unit 450.

In the embodiment, the first control unit 420 has a function of controlling the reading generation unit 113, the first screen storage unit 412, the first display input unit 413, the first temporary storage unit 414, the first transmission destination storage unit 415, the image storage unit 416, the first communication unit 418, the first interface unit 419, and the printing unit 120 of the information processing apparatus 430. Further, the first control unit 420 includes the timer unit 321.

In the embodiment, the information processing apparatus 430 includes a second screen storage unit 431; a second display input unit 432; a second temporary storage unit 433; a second transmission destination storage unit 434; a second communication unit 435; a second interface unit 441; and a second control unit 436.

In the embodiment, the second screen storage unit 431 has a function of storing the transmission destination input screen 124 for the user to input the transmission destination, and the catalog screen 337 for displaying the catalog of the image data. The second display input unit 432 has a display function of displaying the transmission destination input screen 124, and an input function of inputting data such as the transmission destination. The second temporary storage unit 433 has a function of temporarily storing data input through the second display input unit 432 and data received from the image processing apparatus 410.

In the embodiment, the second transmission destination storage unit 434 has a function of storing the transmission destination. The second communication unit 435 includes a second transmission unit 435a and a second receiving unit 435b, and has a function of communicating with the receiving terminal 112 and the image processing apparatus 410. The second interface unit 441 has a function of connecting and communicating with the USB memory unit 450. The second control unit 436 has a function of controlling the second screen storage unit 431, the second display input unit 432, the second temporary storage unit 433, the second transmission destination storage unit 434, the second communication unit 435, and the second interface unit 441 of the information processing apparatus 430.

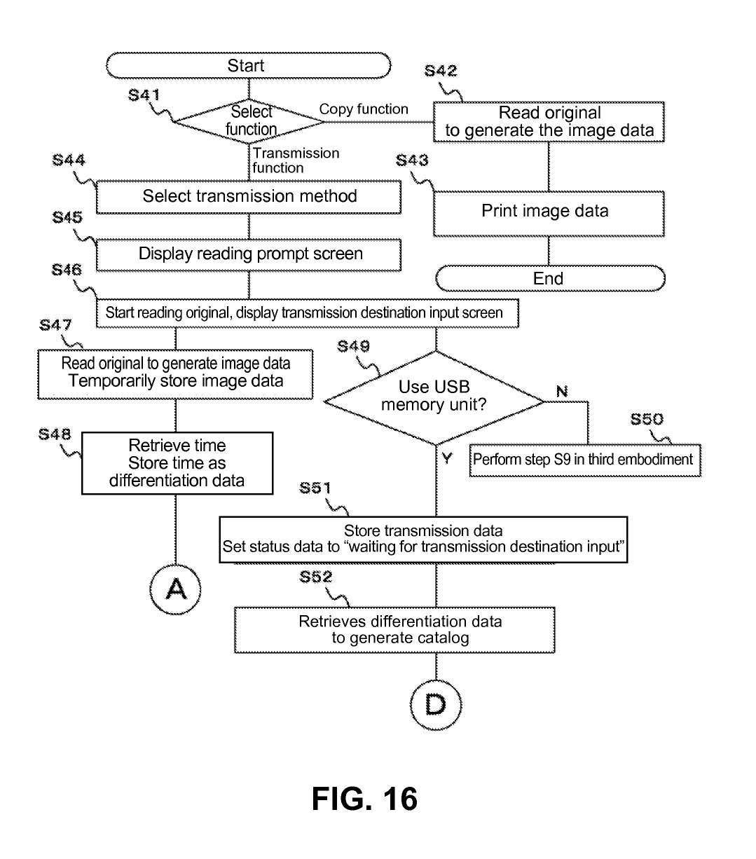

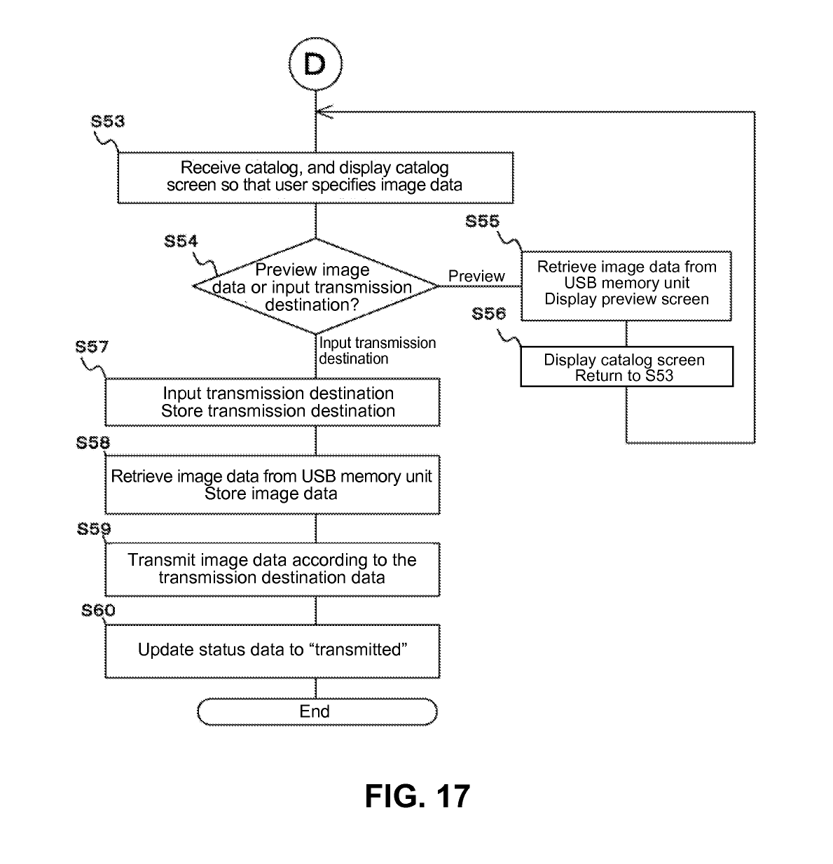

An operation of the image processing system 400 will be explained next with reference to flow charts No. 1 and No. 2 shown in FIGS. 16 and 17. FIG. 16 is the flow chart No. 1 showing the operation of the image processing system 400 according to the fourth embodiment of the present invention. FIG. 17 is the flow chart No. 2 showing the operation of the image processing system 400 according to the fourth embodiment of the present invention.

As shown in FIG. 11, in the image processing apparatus 410, the first control unit 420 starts the first display input unit 413 first, so that the function selection screen is displayed on the first display input unit 413. Accordingly, in step S41, it is possible for the user to select one of the copy function and the transmission function.

In step S42, when the user selects the copy function, the first control unit 420 starts the reading generation unit 113, so that the reading generation unit 113 reads the original to generate the image data. Then, the first control unit 420 controls the first temporary storage unit 414 to temporarily store the image data thus generated. In step S43, the first control unit 420 starts the printing unit 120, so that the printing unit 120 prints the image data temporarily stored in the first temporary storage unit 414, thereby completing the process.

In step S44, when the user selects the transmission function, the first control unit 420 displays the transmission method selection screen on the first display input unit 413, so that the user can selects the transmission method. Then, the first control unit 420 controls the image storage unit 416 to store the transmission method thus selected. In the embodiment, when the receiving terminal 112 is, for example, the PC, the user specifies an electric mail as the corresponding transmission method.

In step S45, the first control unit 420 displays the reading prompt screen 122 on the first display input unit 413. In step S46, when the user pushes or touches the start button 123 of the reading prompt screen 122, the first control unit 420 starts the reading generation unit 113, so that the reading generation unit 113 starts reading the original thus set. At the same time, the first control unit 420 displays a storage selection screen on the first display input unit 413, so that the user selects whether the USB memory unit 450 is used.

In step S47, the reading generation unit 113 reads the original to generate the image data, and the first control unit 420 controls the image storage unit 416 to temporarily store the image data generated with the reading generation unit 113. In step S48, the first control unit 420 retrieves a time when the image data is generated from the timer unit 321, and controls the image storage unit 416 to store the time as the differentiation data. In step S49, the first control unit 420 prompts the user to select whether the USB memory unit 450 is used through the storage selection screen. In step S50, when the user selects that the USB memory unit 450 is not used, step S9 in the third embodiment is performed.

In step S51, when the user selects that the USB memory unit 450 is used, the first control unit 420 retrieves the image data and the differentiation data from the image storage unit 416, and stores the image data and the differentiation data in the USB memory unit 450 through the first interface unit 419. Further, the first control unit 420 retrieves the transmission method data from the first temporary storage unit 414, and stores the transmission data in the USB memory unit 450 through the first interface unit 419. Further, the first control unit 420 sets the status data to “waiting for transmission destination input”.

In step S52, in the information processing apparatus 430, the second control unit 436 retrieves the differentiation data from the USB memory unit 450 through the second interface unit 441 to generate the catalog of the image data. In step S53, the second control unit 436 controls the second display input unit 432 to display the catalog screen 337, so that the user specifies the image data in the image specifying region 338 according to information such as the differentiation data displayed in the catalog. In step S54, the user pushes or touches the preview button 339 or the transmission destination input button 340 so that the user selects whether the user wants to preview the image data or input the transmission destination.

In step S55, when the user pushes or touches the preview button 339, the second control unit 436 retrieves the image data from the USB memory unit 450 according to the differentiation data of the image data thus specified, and controls the second display input unit 432 to display the preview screen. In step S56, when the user pushes or touches the return button on the preview screen, the second control unit 436 controls the second display input unit 432 to display the catalog screen 337, thereby returning the process to step S53.

When the user pushes or touches the transmission destination input button 340 in step S54, the second control unit 436 displays the transmission destination input screen 124 on the second display input unit 432 according to the transmission method stored in the USB memory unit 450. Accordingly, in step S57, the user inputs the transmission destination, and the second control unit 436 controls the second temporary storage unit 433 to store the transmission destination thus input as the transmission destination data. In step S58, the second control unit 436 retrieves the image data thus specified from the USB memory unit 450, and controls the second temporary storage unit 433 to store the image data.

In step S59, the second control unit 436 controls the second transmission unit 435a to transmit the image data thus specified to the receiving terminal 112 according to the transmission destination data. In step S60, after the second transmission unit 435a transmits the image data, the second control unit 436 updates the status data corresponding to the image data stored in the USB memory unit 450 to “transmitted”, thereby completing the process.

As described above, in the fourth embodiment, after the image processing apparatus 410 reads the original to generate the image data, the image data is stored in the USB memory unit 450. Accordingly, it is possible to retrieve and transmit the image data on the information processing apparatus 430 later. As a result, it is possible for the user to store only the image data read by the user in the USB memory unit 450, and to display the catalog of the image data on the information processing apparatus 430, thereby making it easy to select the image data. Further, it is possible for the user to easily carry the image data stored in the USB memory unit 450.

The disclosure of Japanese Patent Application No. 2010-147772, filed on Jun. 29, 2010, is incorporated in the application by the reference.

While the invention has been explained with reference to the specific embodiments of the invention, the explanation is illustrative and the invention is limited only by the appended claims.

What is claimed is:

1. An image processing apparatus to be connected to a receiving terminal for being capable of communicating with the receiving terminal, comprising:
a reading generation unit for reading an original to generate image data;
a display input unit for displaying an input screen of an identification mark of the receiving terminal so that a user inputs the identification mark;
a transmission unit for transmitting the image data to the receiving terminal according to the identification mark; and
a control unit for controlling the reading generation unit to start reading the original and the display input unit to display the input screen.

2. The image processing apparatus according to claim 1, further comprising an identification mark storage unit for storing the identification mark in advance, said display input unit being arranged to display the identification mark stored in the identification mark storage unit in the input screen so that the user specifies and inputs the identification mark.

3. The image processing apparatus according to claim 2, wherein said receiving terminal is a personal computer, said identification mark being an electric mail address.

4. The image processing apparatus according to claim 2, wherein said receiving terminal is a facsimile, said identification mark being a facsimile number.

5. An image processing system, comprising:
a receiving terminal; and
an image processing apparatus connected to the receiving terminal for being capable of communicating with the receiving terminal,
wherein said image processing apparatus comprises:
a reading generation unit for reading an original to generate image data;
a first display input unit for displaying a selection screen so that a user selects whether an identification mark of the receiving terminal is input on the image processing apparatus;
a control unit for controlling the reading generation unit to start reading the original and the first display input unit to display the selection screen, and for controlling the first display input unit to display a first input screen of the identification mark so that the user inputs the identification mark when the user selects that the identification mark is input on the image processing apparatus;
a first transmission unit for transmitting the image data to the receiving terminal according to the identification mark; and
an image storage unit for storing the image data when the user selects that the identification mark is not input.

6. The image processing system according to claim 5, further comprising an information processing apparatus connected to the image processing apparatus for being capable of communicating with the image processing apparatus, said first transmission unit being arranged to transmit an input request signal to the image processing apparatus when the user selects that the identification mark is not input,
wherein said information processing apparatus comprises:
a second display input unit for displaying a second input screen of the identification mark according to the input request signal so that the user inputs the identification mark; and
a second transmission unit for transmitting the identification mark to the image processing apparatus, said first transmission unit being arranged to transmit the image data stored in the image storage unit to the receiving terminal according to the identification mark received from the information processing apparatus.

7. The image processing system according to claim 5, further comprising an information processing apparatus connected to the image processing apparatus for being capable of communicating with the image processing apparatus, said image storage unit being arranged to store differentiation data for differentiating the image data from other image data,
wherein said information processing apparatus comprises:
a second display input unit for displaying a differentiation data request input screen for requesting the differentiation data so that the user inputs a differentiation data request signal; and
a second transmission unit for transmitting the differentiation data request signal to the image processing apparatus, said first transmission unit being arranged to transmit the differentiation data stored in the image storage unit to the information processing apparatus according to the differentiation data request signal received from the information processing apparatus, said second display input unit being arranged to display the differentiation data received from the image processing apparatus so that the user specifies the differentiation data, and to display a second input screen of the identification mark according to the input request signal so that the user inputs the identification mark when the user specifies the differentiation data, said second transmission unit being arranged to transmit the identification mark and the differentiation data to the image processing apparatus, said control unit being arranged to retrieve the image data from the image storage unit according to the differentiation data, and to control the first transmission unit to transmit the image data to the receiving terminal according to the identification mark.

8. The image processing system according to claim 7, wherein said second display input unit is arranged to display the differentiation data and a preview button for previewing the image data corresponding to the differentiation data, said second transmission unit being arranged to transmit a preview request signal and the differentiation data to the image processing apparatus when the preview button is selected, said control unit being arranged to retrieve the image data from the image storage unit according to the preview request signal and the differentiation data, said first transmission unit being arranged to transmit the image data to the information processing apparatus, said second display input unit being arranged to display the image data.

9. The image processing system according to claim 7, wherein said image processing apparatus further comprises a timer unit, said control unit being arranged to retrieve a time when the image data is generated from the timer unit, and to store the time in the image storage unit as the differentiation data.

10. The image processing system according to claim 7, wherein said reading generation unit is arranged to read a title of the original to generate title data, said control unit being arranged to store the title data in the image storage unit as the differentiation data.

11. The image processing system according to claim 5, wherein said image processing apparatus further comprises an identification mark storage unit for storing at least one identification mark in advance, said first display input unit being arranged to display the at least one identification mark on the first input screen of the identification mark so that the user specifies the at least one identification mark to input the identification mark.

12. The image processing system according to claim 7, wherein said information processing apparatus further comprises an identification mark storage unit for storing at least one identification mark in advance, said second display input unit being arranged to display the at least one identification mark on the second input screen of the identification mark so that the user specifies the at least one identification mark to input the identification mark.

13. The image processing system according to claim 6, wherein said receiving terminal is formed of a personal computer so that the identification mark is an electric mail address of the personal computer.

14. The image processing system according to claim 6, wherein said receiving terminal is formed of a facsimile so that the identification mark is a facsimile number of the personal computer.

15. An image processing system, comprising:
a receiving terminal;
an image processing apparatus connected to the receiving terminal for being capable of communicating with the receiving terminal;
an information processing apparatus connected to the image processing apparatus for being capable of communicating with the image processing apparatus; and
a movable storage unit capable of being connected either of the image processing apparatus and the information processing apparatus,
wherein said image processing apparatus comprises:
a reading generation unit for reading an original to generate image data;
a first display input unit for displaying a selection screen so that a user selects whether an identification mark of the receiving terminal is input on the image processing apparatus;
a first control unit for controlling the reading generation unit to start reading the original and the first display input unit to display the selection screen, for controlling the first display input unit to display a first input screen of the identification mark so that the user inputs the identification mark when the user selects that the identification mark is input on the image processing apparatus, and for storing the image data in the movable storage unit when the user selects that the identification mark is not input on the image processing apparatus; and
a first transmission unit for transmitting the image data to the receiving terminal according to the identification mark, and
wherein said information processing apparatus comprises:
a second display input unit for displaying a second input screen of the identification mark so that the user inputs the identification mark;
a second transmission unit for transmitting the image data to the receiving terminal; and
a second control unit for controlling the second display input unit to display the second input screen of the identification mark, said second control unit being arranged to control the second transmission unit to transmit the image data to the receiving terminal stored in the movable storage unit according to the identification mark when the user inputs the identification mark.

16. The image processing system according to claim 15, wherein said movable storage unit is formed of a USB memory unit.
